(19) United States
(12) Patent Application Publication
(10) Pub. No.: US 2007/0134072 A1
(43) Pub. Date: Jun. 14, 2007

(54) Self-drilling screw

(76) Inventor: Guo-Cai Su, Kaohsiung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/296,213

(22) Filed: Dec. 8, 2005

(51) Int. Cl. F16B 25/10

(52) U.S. Cl. 411/387.1

(57) ABSTRACT

A self-drilling screw includes a head and a shank having a drilling point defined at the distal end thereof; said drilling point further includes a first drilling section adjoining the threaded portion and a second drilling section adjoining the first drilling section. Two cut grooves are defined on the second drilling section and communicating with the first drilling section. Due to the two drilling sections, the making drill point dies are less damaged when shaping merely one section of drilling point. Besides, the smooth surface of the first drilling section provides space to put a trademark.

### BACKGROUND OF THE INVENTION

1. Field of the Invention

The present invention relates to a self-drilling screw, particularly to cause minor damage on the making drill point die when shaping the drilling point.

2. Description of the Related Art

Generally, the length of the drilling point of a self-drilling screw is designed according to the thickness of the object that a self-drilling screw is going to penetrate. An example of long drilling point of self-drilling screw is described below.

Referring to FIG. 1, a conventional self-drilling screw 1 comprises ahead 11 and 12 extending therefrom. Said shank 12 has a threaded portion 122 and a drilling point 123. The drilling point 123, defined closing to the shank point, includes a cylindrical portion and a cone-shaped portion 124 tapering to the shank point. Two cut grooves 125 are defined on said drilling point 123 to form a cutting edge 126 on the boundary of the cut grooves 125 and the outer periphery of the cylindrical portion and the boundary of the cut grooves 125 and outer periphery of the cone-shaped portion 124.

In use, the conventional self-drilling screw has several defects.
1. The cutting edge on the drilling point cuts the fibers of object to bring the screw into the object. The debris of the fibers will go upward along the cut grooves. However, the cut grooves directly connected to the threaded portion which blocks debris of the fibers to eject out.
2. Further, to produce this conventional self-drilling screw, the making drill point dies are tend to damage easily because the long drilling point needs more pressure to shape.
3. Generally, a conventional self-drilling screw only has the head to put a trademark. However, said head with a concavity is too limited to put a trademark. A trademark has to be relatively small to add on the head.

The present invention intends to provide an improved self-drilling screw with a drilling point which can efficiently drill into the object and reduce the damage of the making drill point dies when shaping its drilling point.

### SUMMARY OF THE INVENTION

The present invention relates to a self-drilling screw that comprises a head and a shank, having threaded portion adjoining the head and a drilling point without threads, adjoining the threaded portion. Said drilling point further includes the first drilling section closing to the threaded section and the second drilling section closing to the shank point. A cone-shaped portion is defined at the distal end of the first drilling section, tapering to the shank point. Two cut grooves are defined on the second drilling section and communicating with the first drilling section.

The present invention will obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the conventional self-drilling screw;

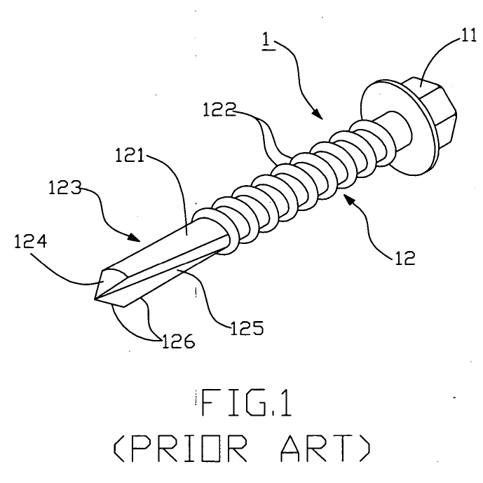

FIG. 2 is a perspective view to show the preferred embodiment of the present invention;

FIG. 3 shows a preferring embodiment of the self-drilling screw penetrates into an object.

### DETAILED DESCRIPTION OF THE PREFERRED EMBODIMENTS

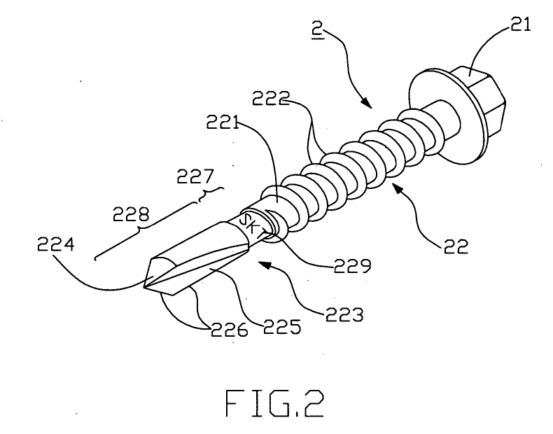

Referring to FIG. 2, the self-drilling screw 2 of the present invention comprises a head 21 and a shank 22 connected to the head 21, said shank 22 including a threaded portion 221 with threads 222 defined thereon and a drilling point 223 without any threads. Said threaded portion 221 is adjoining the head 21 and said drilling point 223 further having a first drilling section 227 adjoining the threaded portion 221 and a second drilling section 228 adjoining the first drilling section 227. The second drilling section 228, including a cylindrical portion and a cone-shaped portion 224 tapering to the shank point, has two cut grooves 225 defined thereon communicating with the first drilling section 227. A plurality of cutting edges 226 is formed on the boundary of the outer periphery of the cone-shaped portion 224 and cut grooves 225 and boundary of the outer periphery of the cylindrical portion and cut grooves 225. Said first drilling section 227 has a smooth outside surface 229 which is an area sufficient to put a trademark.

Besides, the outside diameter of the first drilling section is smaller than the outside diameter of the second drilling section.

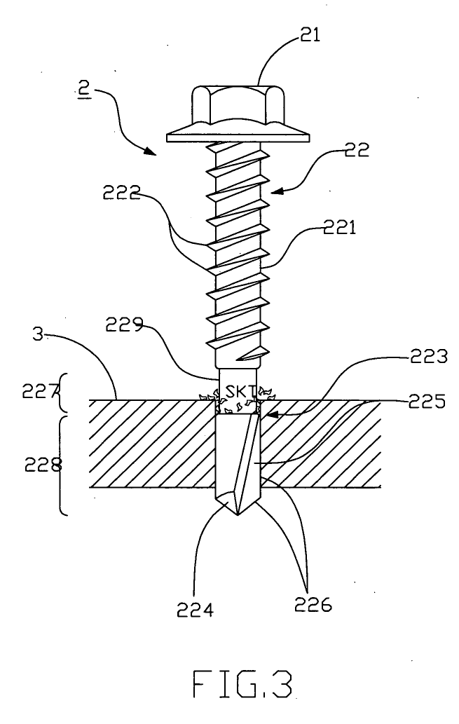

As shown in the FIG. 3, during the operation, the cutting edge on the second drilling section cuts the fibers of the object to bring screw into the object. The debris of fibers is carried through the cut grooves to the first drilling section. The first drilling section is a slightly sinking section providing space to eject out the debris of fibers.

As indicated above, the invention has the following advantages:
1. Usage duration of the making drill point dies extending Due to the two sections of the drilling point, the making drill point dies only need to shape the drilling section with cut grooves which reduces damage of the making drill point dies.
2. efficiently debris ejecting Due to the fact that cut grooves are communicated to the first drilling section with smaller outside diameter, the debris can be ejected out smoothly.
3. trademark adding Due to the smooth outside surf ace on the second drilling section, the self-drilling screw has sufficient space to add a trademark.

While we have shown and described the embodiment in accordance with the present invention, it should be clear to those skilled in the art that further embodiments may be made without departing from the scope of the present invention.

I claim:

1. A self-drilling screw comprising:
A head and a shank extending therefrom, said shank includes a threaded portion adjoining the head and a drilling point closing to the shank point. Said drilling point further has a first drilling section without threads, adjoining the threaded portion and a second drilling section, adjoining the first drilling section. Said second drilling section includes a cone-shaped portion defined at the distal end thereof and a cylindrical portion. Two cut grooves are defined on the second drilling section and communicated with the first drilling section. A cutting edge is formed on the boundary of the cut grooves and the outer periphery of the cylindrical portion and the boundary of the cut grooves and the outer periphery of the cone-shaped portion.

2. The self-drilling screw as claimed in claim 1, wherein the outside diameter of the first drilling section is smaller than the outside diameter of the second drilling section.

3. The self-drilling screw as claimed in claim 1, wherein the surface of the first drilling section has a mark.
